(19) United States
(12) Patent Application Publication
(10) Pub. No.: US 2003/0020404 A1
(43) Pub. Date: Jan. 30, 2003

(54) Method of fabricating a plasma display panel and a front plate of the plasma display panel

(75) Inventors: Yao-Ching Su, Tainan Hsien (TW); Wen-Fa Sung, Hsinchu (TW); Chun-Tang Peng, Miaoli Hsien (TW)

Correspondence Address: c/o LADAS & PARRY, Suite 2100, 5670 Wilshire Boulevard, Los Angeles, CA, 90036-5679, US

(73) Assignee: Acer Display Technology, Inc.

(21) Appl. No.: 10/256,440

(22) Filed: Sep. 26, 2002

Related U.S. Application Data
(62) Division of application No. 09/611,080, filed on Jul. 6, 2000.

(30) Foreign Application Priority Data
Mar. 3, 2000 (TW) 89103794

(51) Int. Cl. H01J 17/49

(52) U.S. Cl. 313/582

(57) ABSTRACT

A method of fabricating a plasma display panel and a front plate of the plasma display panel are disclosed. The first step of the method is to provide a front glass substrate having a pixel area and a bonding area. Next, an electrode, which has a pixel electrode positioned at the pixel area and a bonding electrode positioned at the bonding area, is formed on the front substrate. Then, a dielectric layer is formed over the pixel area and the bonding area to cover the pixel electrode and the bonding electrode, respectively. Thereafter, a rear plate is sealed to the front substrate by a sealing material so that the rear plate covers the pixel area without covering the bonding area. Then, the dielectric layer formed on the bonding area is removed to expose the bonding electrode.

### BACKGROUND OF THE INVENTION

1. Field of the Invention

The present invention relates to a method of fabricating a plasma display panel (PDP) as well as a front plate of the plasma display panel. More particularly, the present invention relates to a method of fabricating a plasma display panel and a front plate that is capable of preventing oxidation of the electrodes in bonding area of the plasma display panel.

2. Description of the Related Art

Recently, a variety of flat panel displays, such as a liquid crystal display (LCD) and a plasma display panel (PDP) have been intensively developed for replacing the cathode ray tubes (CRT) display. In PDP, the emitting gas is ionized for emitting ultra violet light and exciting the RBG phosphors to produce visible light. The advantages of the PDP include large display area, wide viewing angle, and intense brightness.

Referring to FIG. 1, a perspective view of a part of a plasma display panel is depicted. Typically, a plasma display panel is constituted of a front plate 10 and a rear plate 12. The front plate 10 comprises a front glass substrate 14, a plurality of scanning electrodes 16, a transparent dielectric layer 18, and a protective layer 20 consisting of MgO. In addition, every scanning electrode 16 contains a sustaining electrode 22 and a bus electrode 24. A voltage is applied to two adjacent sustaining electrodes 22 to generate plasma. In order to allow visible light to pass through the front substrate 14, each of the sustaining electrodes 22 utilizes a transparent material such as indium tin oxide (ITO) or SnO₂. However, the high resistance of the sustaining electrode is not suitable for electrical conduction. For this reason, a bus electrode 24 consisting of metal is disposed on every sustaining electrode 22 to enhance conductivity.

Furthermore, the rear plate 12 comprises a rear glass substrate 30, a plurality of data electrodes 32, a dielectric layer 33, a plurality of partition walls 34, and a plurality of fluorescence layers 36. The rear plate 12 and the front plate 10 are perpendicular to each other. The space formed between two adjacent partition walls 34 and under the region between two scanning electrodes 16 is a region for generating plasma and is called “a pixel”. The data electrode 32 is used for controlling the generation of the plasma. The scanning electrodes 16 are used to maintain the plasma. Fluorescence layers 36 can absorb ultra violet (UV) light to emit visible light such as red, green, or blue light. The partition walls 34 are used to prevent UV light from transmitting to the adjacent fluorescence layer so as not to produce a mixing color.

FIGS. 2A through 2C illustrate one of the prior arts.

Referring to FIG. 2A, the front glass substrate 300 includes a pixel area and a bonding area. A bus electrode, which includes a pixel bus electrode 312a positioned at the pixel area and a bonding bus electrode 312b positioned at the bonding area, is formed on the front glass substrate 300. A sustaining electrode 311 formed between the front glass substrate 300 and the pixel bus electrode 312a is disposed on the pixel area. Each of the bus electrodes 312a-312b is made of three metal layers including a chromium (Cr) layer, a copper (Cu) layer, and a chromium (Cr) layer.

Next, as shown in FIG. 2B, an oxide layer is coated over the front glass substrate 300. Subsequently, a first heating step under a temperature of about 500° C. to 600° C. is utilized to sinter the oxide layer to form a dielectric layer 313. The dielectric layer 313 covers the pixel area without covering the bonding area of the front glass substrate 300 so that the bus electrode 312b positioned at bonding area is exposed.

After that, as shown in FIG. 2C, a rear plate 320 is sealed with the front glass substrate 300 containing the dielectric layer 313 by a sealing material 318 coated at a specific position between the front glass substrate 300 and the rear plate 320. A second heating step is then proceeded under a temperature of about 400° C. to 450° C. to strengthen the sealing material 318. Thereafter, the bus electrode 312b positioned at the bonding area is connected to a plurality of external driving circuits (not shown).

However, the exposed bus electrode 312b is easily oxidized during these heating steps and a disconnection between the bus electrode 312b and the driving circuit will happen to cause reliable problems in a plasma display panel.

### SUMMARY OF THE INVENTION

In view of the above disadvantages, an object of the present invention is to provide a method of fabricating a plasma display panel that is capable of preventing oxidation of the bus electrode positioned at the bonding area and eliminating the disconnection problems of the prior art.

Another object of the present invention is to provide a front plate of the plasma display panel capable of preventing oxidation of the bus electrode positioned at the bonding area.

According to the present invention, the above objects are accomplished by a method of fabricating a plasma display panel including steps of: (a) providing a front substrate having a pixel area and a bonding area; (b) forming an electrode on said front substrate, the electrode has a pixel electrode positioned at said pixel area and a bonding electrode positioned at said bonding area; (c) forming a dielectric layer over said pixel area and said bonding area to cover said pixel electrode and said bonding electrode; (d) providing a rear plate and sealing the rear plate to the front substrate by a sealing material so that the pixel area is covered by the rear plate and the bonding area is exposed; and (e) removing the dielectric layer above at said bonding area to expose the bonding electrode.

Furthermore, in the method of fabricating a plasma display panel, the step (e) can be performed by a wet etching method using an acid solution selected from the group consisting of nitric acid (HNO₃) and hydrochloric acid (HCl).

Furthermore, in the method of fabricating a plasma display panel, the bonding electrode includes two metal layers containing copper and chromium.

Furthermore, the method of fabricating a plasma display panel can further comprise a first heating step for sintering the dielectric layer. The first heating step is performed at a temperature of about 500° C. to 600° C. before the step (d).

In addition, the method of fabricating a plasma display panel includes a second heating step for sintering the sealing material. The second heating step is performed at a temperature of about 400° C. to about 450° C. after the step (d).

The above objects are accomplished by providing a front plate of a plasma display panel comprising a front substrate having a pixel area and a bonding area, two electrodes disposed on the front substrate in parallel, each of the electrode has a pixel electrode positioned at the pixel area and a bonding electrode positioned at the bonding area, and a dielectric layer disposed between the two bonding electrodes and the bottom surface of said dielectric layer is coplanar with the bottom surfaces of the two bonding electrodes.

Furthermore, in the front plate according to the present invention, the dielectric layer covers the pixel electrodes.

Furthermore, in the front plate according to the present invention, the pixel electrodes are bus electrodes.

Also, the front plate according to the present invention further comprises a sustaining electrode disposed between each pixel electrode and the front plate.

### BRIEF DESCRIPTION OF THE DRAWINGS

The preferred embodiment of the invention is hereinafter described with reference to the accompanying drawings in which:

FIG. 1 is a perspective view of a plasma display panel in the prior art;

FIGS. 2A through 2C are top views illustrating the steps for fabricating a plasma display panel of the prior art;

FIGS. 3A, 4A, 5A are top views illustrating the steps involved in fabricating a plasma display panel according to the first embodiment of the present invention;

FIG. 3B is cross-sectional view along the CD line shown in FIG. 3A;

FIG. 4B is cross-sectional view along the EF line shown in FIG. 4A;

FIG. 5B is cross-sectional view along the GH line shown in FIG. 5A;

FIGS. 6A is a cross-sectional view illustrating the step for fabricating a plasma display panel according to the second embodiment of the present invention; and

FIG. 6B is cross-sectional view along the MN line shown in FIG. 6A.

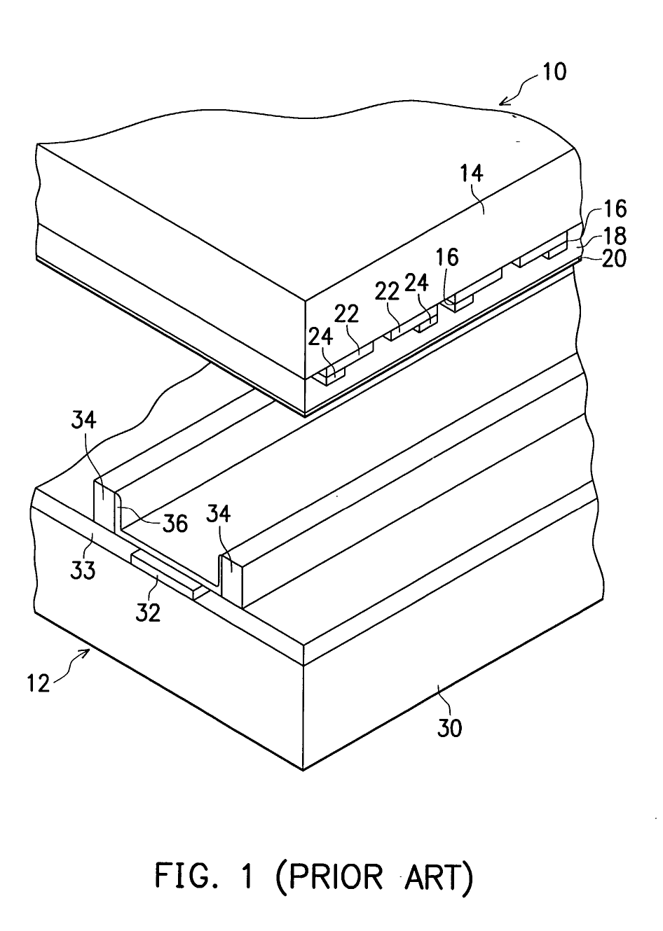

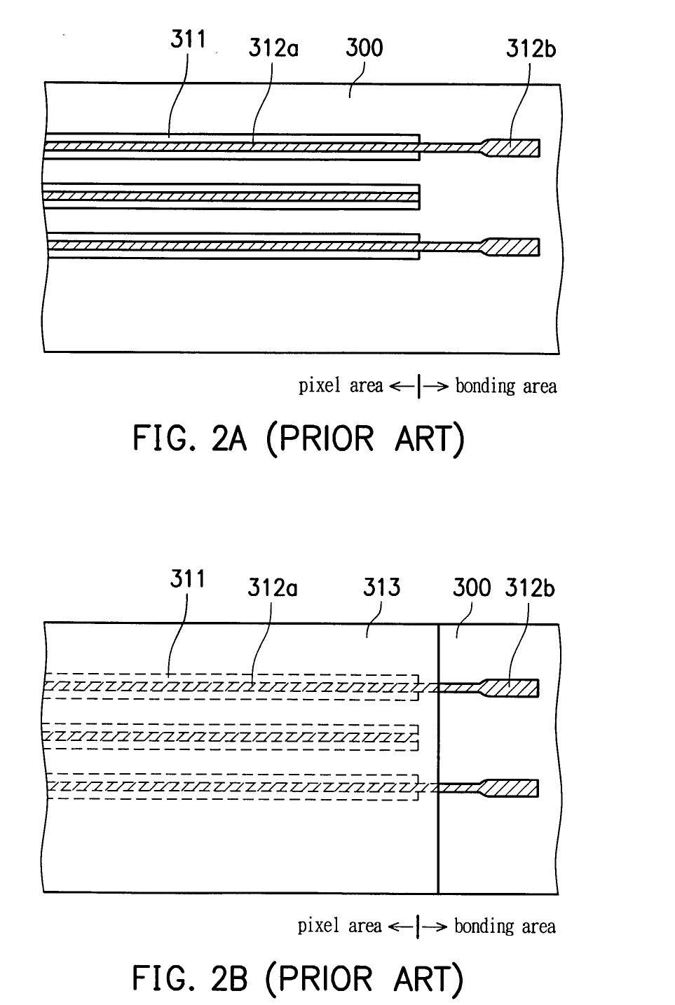

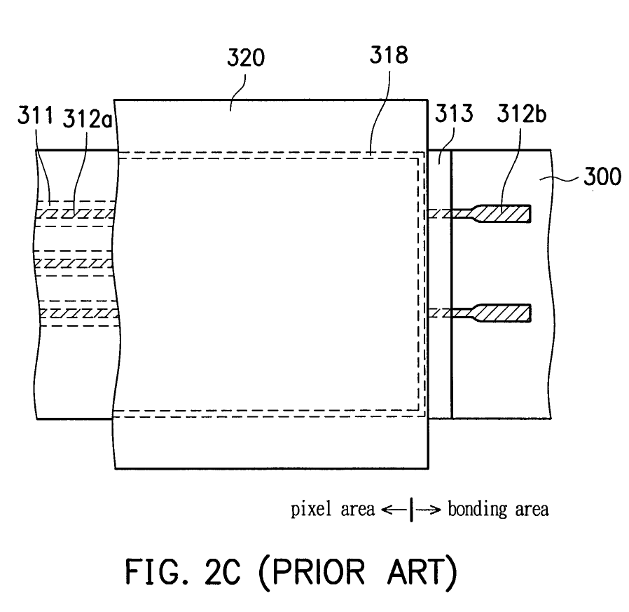

### DESCRIPTION OF THE PREFERRED EMBODIMENTS

First Embodiment

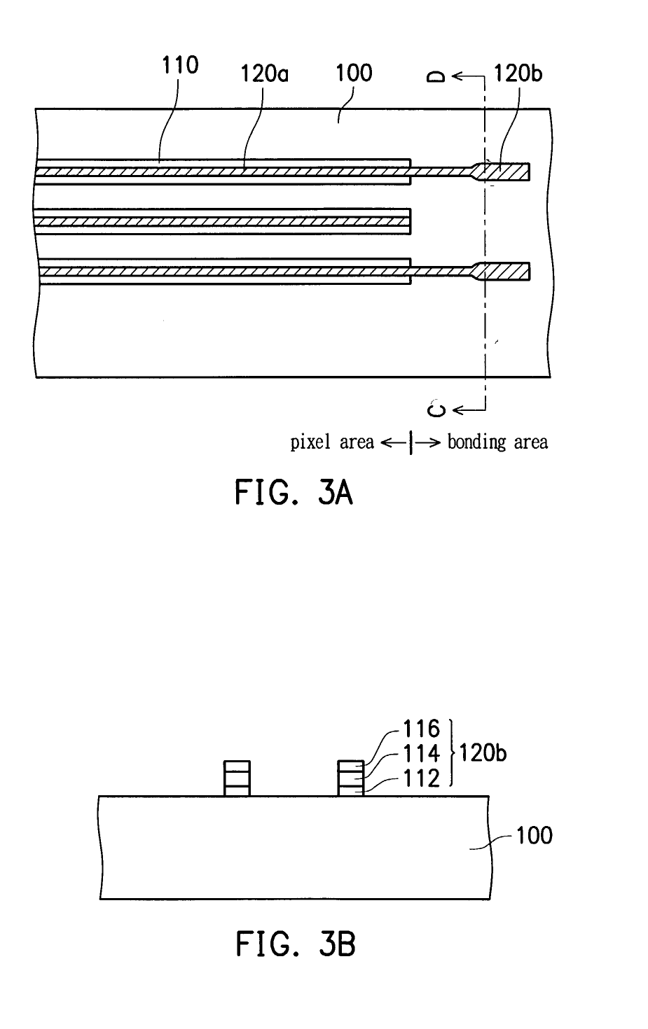

The first embodiment of the invention is illustrated in reference to FIGS. 3A˜5A and FIGS. 3B˜5B.

Referring to FIG. 3A, the front glass substrate 100 has a pixel area and a bonding area. An electrode, preferably a bus electrode, is formed. In this embodiment, the bus electrode includes a pixel bus electrode 120a positioned at the pixel area and a bonding bus electrode 120b positioned at the bonding area. A sustaining electrode 110 is formed on the pixel area of the front glass substrate 100 and disposed between the front glass substrate 100 and the pixel bus electrode 120a. Next, as shown in FIG. 3B, each of the bus electrodes 120a-120b comprises three metal layers, such as a chromium (Cr) layer 112, a copper (Cu) layer 114, and a chromium (Cr) layer 116. The copper layer 114 is served as a conductive material and can be replaced by other materials such as aluminum (Al).

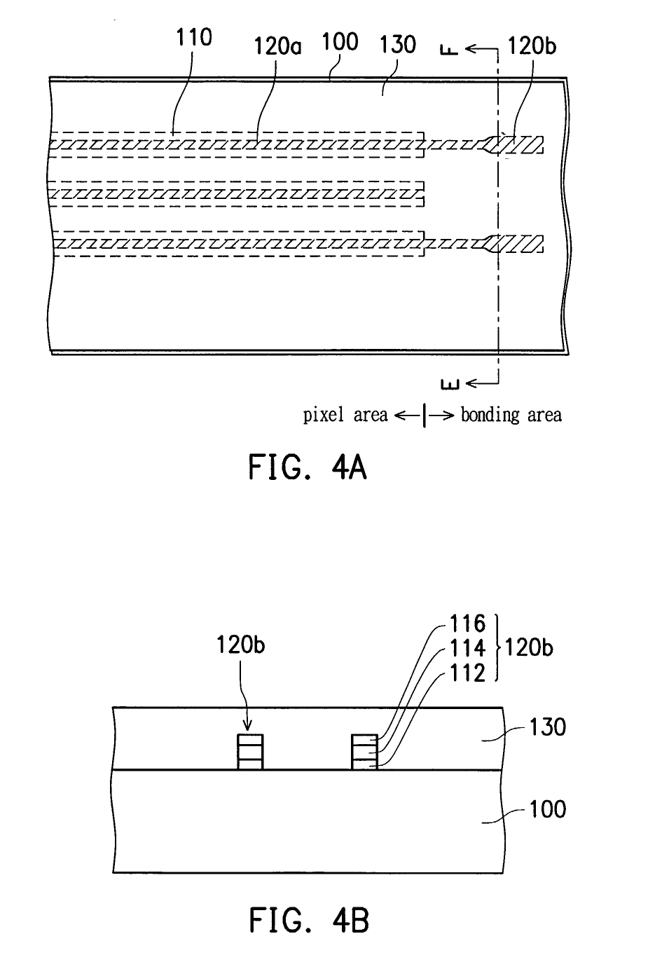

Next, as shown in FIG. 4A, an oxide layer comprising SiO₂, PbO, and Ba₂O₃ is coated over the front glass substrate 100 to cover the pixel bus electrode 120a and the bonding bus electrode 120b. Subsequently, a first heating step under a temperature of about 500° C. to 600° C. is proceeded to sinter the oxide layer to form a dielectric layer 130 as shown in FIG. 4B. Because the dielectric layer 130 covers the bonding bus electrode 120b, the oxidation of the chromium layer 116 of the bonding bus electrode 120b will not occur during the first heating step. A protective layer (not shown), such as an MgO layer, is then formed above the dielectric layer 130.

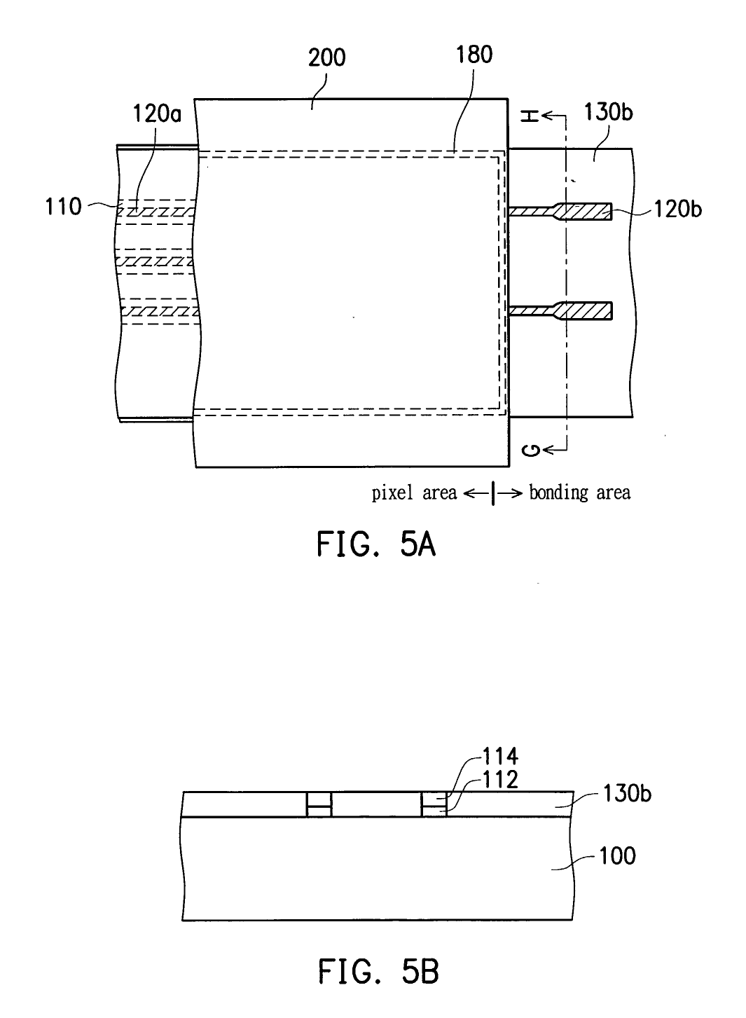

Thereafter, as shown in FIGS. 5A and 5B, a rear plate 200 is provided to cover the pixel area of the front glass substrate 100 and expose the bonding area of the front glass substrate 100. A sealing material 180 including SiO₂, PbO, and Ba₂O₃ is coated at a specific position between the front glass substrate 100 and the rear plate 200. A second heating step under a temperature of about 400° C. to 450° C. is then utilized to strength the sealing material 180 for linking the front glass substrate 100 and the rear plate 200. Next, a part of the dielectric layer 130 formed on the bonding area of the front glass substrate 100 is removed by a wet etching process utilizing a hydrochloric acid (HCl) solution. The wet etching process will stop when the bonding bus electrode 120b is exposed. In the first embodiment, in addition to the dielectric layer 130, the chromium layer 116 of the boding bus electrode 120b is also removed by the hydrochloric acid. Therefore, the bonding bus electrode 120b is then composed of the copper layer 114 and the chromium layer 112 after the wet etching process. Since the color of copper is red which is different from the color of the dielectric layer 130b, the end point of the etching process can be easily controlled by the exposure of the copper layer 114. The upper surface of the dielectric layer 130b is coplanar with the upper surface of the bonding bus electrode 120b, and the bottom surface of the dielectric layer 130b is formed coplanar with the bottom surface of the bonding electrode 120b.

Second Embodiment

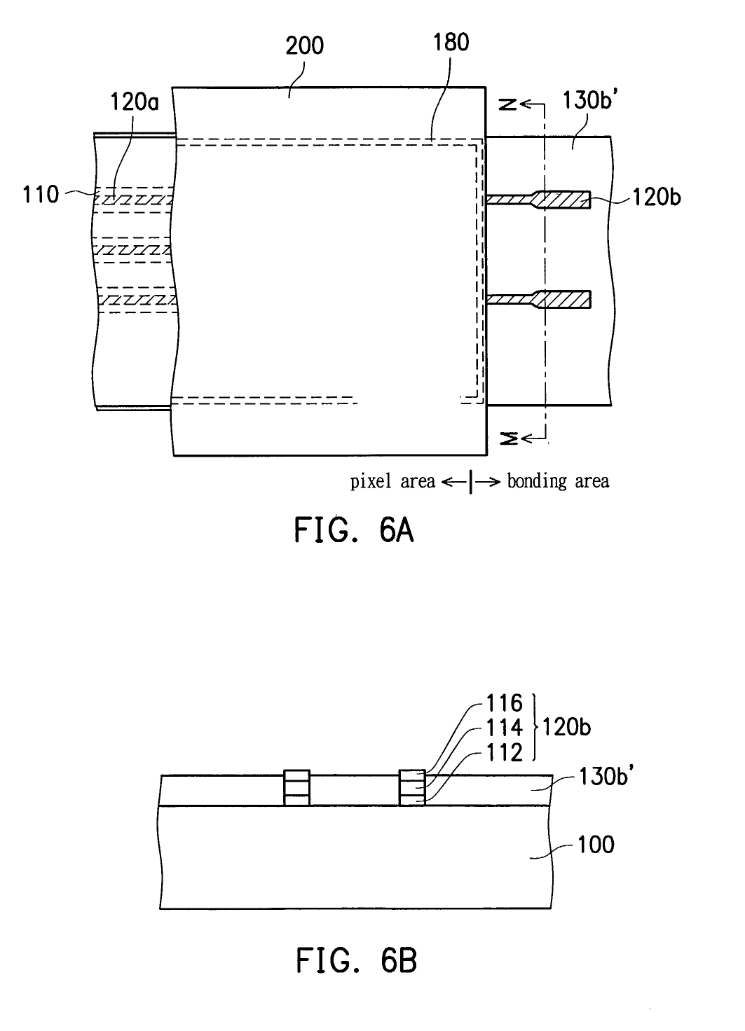

In this embodiment, the manufacturing steps depicted in reference to FIGS. 3A to 4B are the same, and will not be illustrated again. Thereafter, a wet etching process using a nitric acid (HNO₃) is utilized to replace the hydrochloric acid described in the first embodiment. As shown in FIGS. 6A and 6B, only the dielectric layer 130b′ formed on the bonding area of the front glass substrate 100 can be removed by the nitric acid. In contract to the first embodiment, the chromium layer 116 will not be removed by the wet etching process. Therefore, the bonding bus electrode 120b consists of the chromium layer 116, the copper layer 114, and the chromium layer 112. The end point of the wet etching process can be easily controlled by the exposure of the chromium layer 116. As shown in FIG. 6B, the upper surface of the dielectric layer 130b′ is not coplanar with the upper surface of the bonding bus electrode 120b, but the bottom surface of the dielectric layer 130b′ is coplanar with the bottom surface of the bonding bus electrode 120b.

The invention provides a method of fabricating a plasma display panel. First, the dielectric layer is formed all over the front glass substrate to cover both the pixel area and the bonding area. Then, a heating step proceeds for sintering the dielectric layer. After the heating step, the dielectric layer formed on the bonding area of the front glass substrate is selectively removed to expose the bonding bus electrodes on the bonding area. As a result, the bonding electrode will not be oxidized during the heating step. The problem of disconnection between the bonding bus electrode and an outer circuit, which is occurred in the prior art, can be eliminated. Accordingly, the quality of the plasma display panel can be enhanced.

Furthermore, the invention provides a method of fabricating a front plate of the plasma display panel. The front plate includes a front glass substrate having a pixel area and a bonding area and two electrodes disposed on the front glass substrate in parallel. Each electrode includes a pixel electrode formed on the pixel area and a bonding electrode formed on the bonding area. The front plate further includes a dielectric layer disposed between two bonding electrodes and the bottom surface of the dielectric layer is coplanar with the bottom surfaces of two bonding electrodes.

While the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modifications or embodiments as may fall within the scope of the invention defined by the following claims and their equivalents.

What is claimed is:

1. A method of fabricating a plasma display panel, comprising the steps of:
(a) providing a front substrate having a pixel area and a bonding area;
(b) forming an electrode on said front substrate, said electrode including a pixel electrode formed at said pixel area and a bonding electrode formed at said bonding area;
(c) forming a dielectric layer over said pixel area and said bonding area to cover said pixel electrode and said bonding electrode;
(d) providing a rear plate, and sealing said rear plate with said front substrate by a sealing material so that said pixel area of said front substrate is covered by the rear plate and said bonding area of the front substrate is exposed; and
(e) removing said dielectric layer above said bonding area to expose said bonding electrode.

2. A method of fabricating a plasma display panel as claimed in claim 1, wherein said step (e) is performed by a wet etching process.

3. A method of fabricating a plasma display panel as claimed in claim 2, wherein said wet etching process is using an acid solution selected from the group consisting of nitric acid and hydrochloric acid.

4. A method of fabricating a plasma display panel as claimed in claim 1, before said step (d), further comprising a first heating step for sintering said dielectric layer.

5. A method of fabricating a plasma display panel as claimed in claim 4, wherein said first heating step is performed at a temperature of about 500° C. to about 600° C.

6. A method of fabricating a plasma display panel as claimed in claim 4, after said step (d), further comprising a second heating step for sintering said sealing material.

7. A method of fabricating a plasma display panel as claimed in claim 6 wherein said second heating step is performed at a temperature of about 400° C. to about 450° C.

8. A front plate of a plasma display panel, comprising:
a front substrate having a pixel area and a bonding area;
two electrodes disposed on said front substrate in parallel, each of said electrodes includes a pixel electrode positioned at said pixel area and a bonding electrode positioned at said bonding area; and
a dielectric layer disposed between said two bonding electrodes, wherein the bottom surface of said dielectric layer is coplanar with the bottom surfaces of said two bonding electrodes.

9. A front plate of a plasma display panel as claimed in claim 8, wherein said dielectric layer covers each of said pixel electrode.

10. A front plate of a plasma display panel as claimed in claim 9, wherein each said pixel electrode is bus electrode.

11. A front plate of a plasma display panel as claimed in claim 9, further comprising a sustaining electrode disposed between each said pixel electrode and said front substrate.

12. A front plate of a plasma display panel as claimed in claim 8, wherein said bonding electrode comprises two metal layers including copper and chromium.
